(19) United States
(12) Patent Application Publication
(10) Pub. No.: US 2010/0177041 A1
(43) Pub. Date: Jul. 15, 2010

(54) Method of controlling cursor with multiple and variable speeds through a trackpad

(76) Inventor: Stephen Chen, Changhua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,694

(22) Filed: Mar. 23, 2009

(30) Foreign Application Priority Data
Jan. 9, 2009 (TW) 098100763

(51) Int. Cl. G09G 5/08

(52) U.S. Cl. 345/159; 345/163

(57) ABSTRACT

A method of controlling cursor with multiple and variable speeds through a trackpad aims to be used on a system that controls a cursor on a screen through a trackpad by transforming user's finger position movement vector to a screen cursor position movement vector. Depending on finger touch position and depressing condition of the trackpad, at least an ON condition and an OFF condition are generated, and different alterations of depressing time and finger movement distance are formed. Selected speed parameters can be derived through at least two transformation equations. Multiply the speed parameters and finger coordinate alteration vector, the screen cursor movement vector can be obtained. Thus users can switch different cursor movement speeds and control mouse button function according to requirements to facilitate cursor control.

### BACKGROUND OF THE INVENTION

1. Field of the Invention

The present invention relates to a method of controlling cursor with multiple and variable speeds through a trackpad and particularly to a method allowing users to switch to different cursor movement speeds according to requirements to facilitate control of the cursor.

2. Description of the Prior Art

There are a wide variety of cursor control means available at present. Among them, mouse is most commonly used. However, on notebook computers, the mouse cannot be directly adopted due to size constraint. Hence notebook computers generally have a trackpad to provide mouse function. But the trackpad also has a size constraint. Moving a cursor for a long distance on a screen, such as from the leftmost side to the rightmost side of the screen, user's finger has to move repeatedly many times on the trackpad. By increasing the ratio of the finger movement speed and cursor movement speed on the screen, a smaller finger moving distance can control a greater moving distance of the cursor. Then one sliding of the finger can move the cursor to a targeted position. But a slight shaking of the finger also generates a greater cursor movement. To accurately pinpoint a small icon becomes difficult.

To remedy the aforesaid problem, a dynamic variable speed mechanism has been developed for the trackpad. Adopted such a mechanism, when the finger movement speed is slower the system moves the cursor at a smaller movement ratio. When the finger movement speed is faster the system also moves the cursor at a greater ratio, hence the cursor can be moved for a longer distance faster. To pinpoint a targeted icon, the finger movement speed can be slowed down and the cursor movement speed also is slower. Such an approach can mitigate the drawback of repeatedly finger movements on the trackpad mentioned above. But when the finger is moved very fast, the cursor is moved even faster. User's visual monitoring of the cursor movement is difficult, and adjustment of cursor moving direction and position during cursor movement is not easy. Moreover, moving the finger rapidly and stop moving instantly is a stressful operation to many users. Hence its practicality suffers.

Because of the aforesaid concerns, although most notebook computers have provided a trackpad, many users still prefer to have an additional external mouse and try to shut down the trackpad function when in use.

References of related techniques are discussed below:

Taiwan patent application No. 94135247 discloses a method to generate different movement speeds on a window. It includes procedures of detecting sliding of an object on a touch pad, calculating coordinate values of the object on the touch pad to generate a position information, calculating the size of the object on the touch pad to generate a speed information, generating a moving signal based on the position information and speed information, and moving the window.

Taiwan patent application No. 94105391 discloses a method for setting mouse parameters through different button sets. The method includes procedures as follow:

A. Providing a mouse device which has a memory and a plurality of buttons. The memory stores a mouse parameter and a composite button table which contains parameter setting modes of different button combinations;

B. Detecting whether the buttons are depressed within a selected duration during mouse operation;

C. Comparing whether the combination of the depressed buttons matches one of the button combinations on the composite button table, and proceeding a selected step when the match occurs; and

D. Setting the mouse parameter of the mouse device based on the composite button table according to a parameter setting mode corresponding to the button combination. This reference adjusts mouse movement speed through different buttons.

Taiwan Patent application No. 93112646 discloses a multi-stage mouse displacement resolution setting device allowing users to set mouse displacement resolution through a switch on the mouse. It has a X-Y axes plane displacement detector, a switch circuit and a mouse microcontroller. The X-Y axes plane displacement detector can detect the moving direction and distance of the mouse on a two-dimensional plane. The switch circuit has at least one switch. The mouse microcontroller is coupled with the X-Y axes plane displacement detector and the switch circuit, and determines the resolution value according to ON/OFF conditions of the switch. The mouse microcontroller, based on the detected moving direction and distance, generates a control signal sent to a computer connecting to the mouse to move a mouse cursor on a computer screen. Mouse movement is proceeded according to the resolution value, and the mouse movement speed can be adjusted through the mouse microcontroller.

Taiwan patent application No. 91100508 discloses a mouse pointer device which has a speed controller to accept commands entered by users to regulate cursor movement speed in response to the pointer device movement speed. When the pointer device is in use input speed can be increased or decreased by a user manually. For instance, the speed controller may have a button installed on a mouse abutting the thumb location of the user. Hence through a simple thumb maneuvering, the user can dynamically adjust the cursor movement speed in response to the mouse movement.

Taiwan patent application No. 88110900 discloses a cursor moving method for a pointer device. When a cursor is moved towards a targeted object the cursor is temporarily paused when it arrives the area where the targeted object is located. After a selected duration the cursor can pass over the targeted object area. In the targeted object area the movement speed of the cursor slows down. However, when the cursor is spaced from the targeted object within a selected distance it is accelerated to move towards the targeted object.

### SUMMARY OF THE INVENTION

All the techniques adopted in the aforesaid references do not provide convenient switching of different cursor movement speeds according to requirements. Therefore the present invention aims to provide a method of controlling cursor with multiple and variable speeds through a trackpad adopted fore use on a system which controls a screen cursor through a mouse. The method can transform a finger position movement vector to a screen cursor position movement vector. The invention includes a trackpad which has a touch pad movable up and down and a depressible switch located thereunder. The depressible switch can be driven to an ON condition when the trackpad is depressed by a finger. The method of the invention includes at least the following steps:

a. detecting a finger on a trackpad, and setting a depressible switch in an OFF condition;

b. detecting a coordinate alteration vector of the finger and calculating finger movement speed;

c. executing a mouse button function when total accumulated cursor movement vector is smaller than a displacement set value or accumulated ON time is smaller than a time set value while the depressible switch is in the ON condition;

d. preparing at least two speed parameter process equations, and calculating a speed parameter (a) through a first process equation f (v) while the depressible switch is in the OFF condition; and calculating the speed parameter (a) through a second process equation g (v) while the depressible switch is in the ON condition; and

e. multiplying the finger coordinate alteration vector and the speed parameter (a) to get a screen cursor movement vector.

In the first process equation f (v)=k₁*V+n₁=a, and the second process equation g (v)=k₂*V+n₂=a, k₁, k₂, n₁, and n₂ are constants; v is the movement speed of the finger on the trackpad; k₁<k₂, and n₁<n₂. Hence at the same speed the speed parameter a derived from the second process equation g (v) is greater than another speed parameter a derived from the first process equation f (v).

At the step c set forth above, the mouse button function is executed when the total accumulated cursor movement vector is smaller than the displacement set value while the depressible switch is in the ON condition or the accumulated time in the ON condition is smaller than the time set value. As the general trackpad (or touch pad) performs the mouse button function by tapping, erroneous actions frequently occur. The present invention adopts depressing to displace the tapping. As depressing movement is similar to accelerating movement, the invention can use depressing time and displacement amount as control means.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a schematic view of the procedures of the control method of the invention.

FIG. 3 is the flow chart of a first embodiment of the invention.

FIG. 4 is the flow chart of a second embodiment of the invention.

FIG. 5 is the flow chart of a third embodiment of the invention.

### DESCRIPTION OF THE PREFERRED EMBODIMENTS

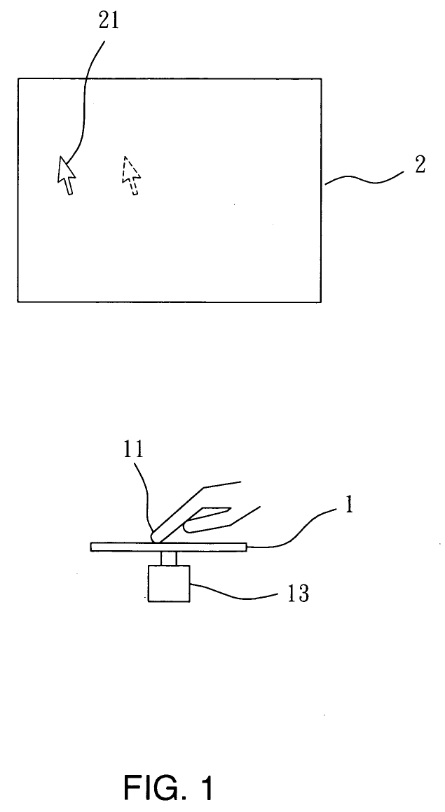

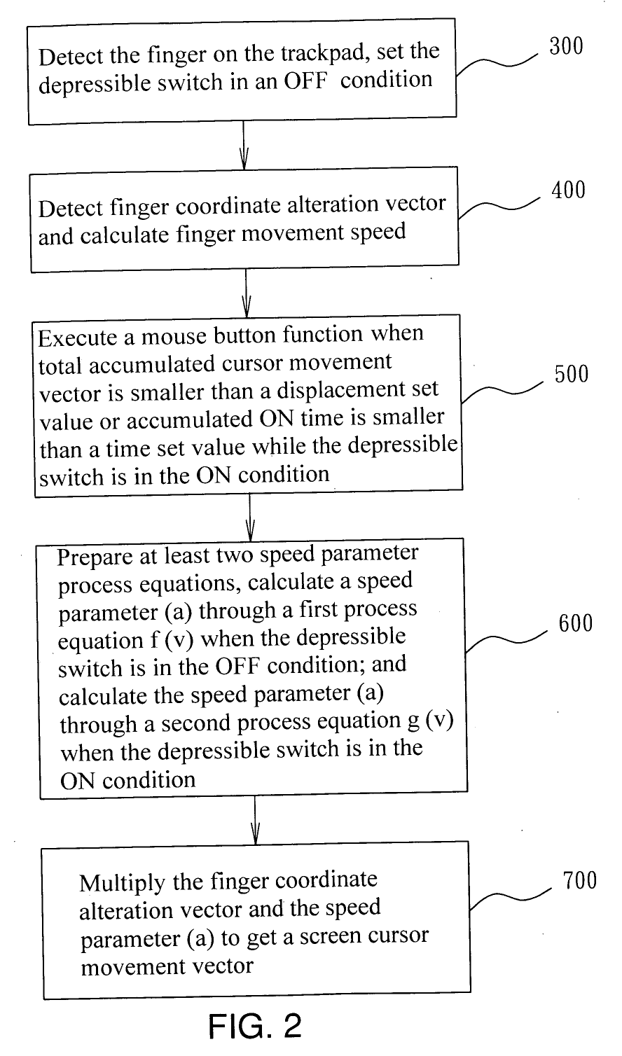

Referring to FIG. 1, the method of the invention is implemented through at least a trackpad 1 which has a depressible switch 13 and a screen 2 having a cursor 21 shown thereon. The trackpad 1 can detect touch positions of a user's finger 11 and moving directions of the finger. Through these elements the method of the invention is executed. The trackpad 1 is a touch pad movable up and down, and has the depressible switch 13 located thereunder. Depressing of the finger 11 on the trackpad 1 can drive the depressible switch 13 to an ON condition. The method includes at least the following steps (also referring to FIG. 2):

a. detecting a finger on a trackpad, and setting a depressible switch in an OFF condition (step 300);

b. detecting a finger coordinate alteration vector and calculating a finger movement speed (step 400);

c. executing a mouse button function when total accumulated cursor movement vector is smaller than a displacement set value or accumulated ON time in the ON condition is smaller than a time set value while the depressible switch is in the ON condition (step 500);

d. preparing at least two speed parameter process equations, and calculating a speed parameter (a) through a first process equation f (v) while the depressible switch is in the OFF condition; and calculating the speed parameter (a) through a second process equation g (v) while the depressible switch is in the ON condition (step 600); and

e. multiplying the finger coordinate alteration vector and the speed parameter (a) to get a screen cursor movement vector (step 700).

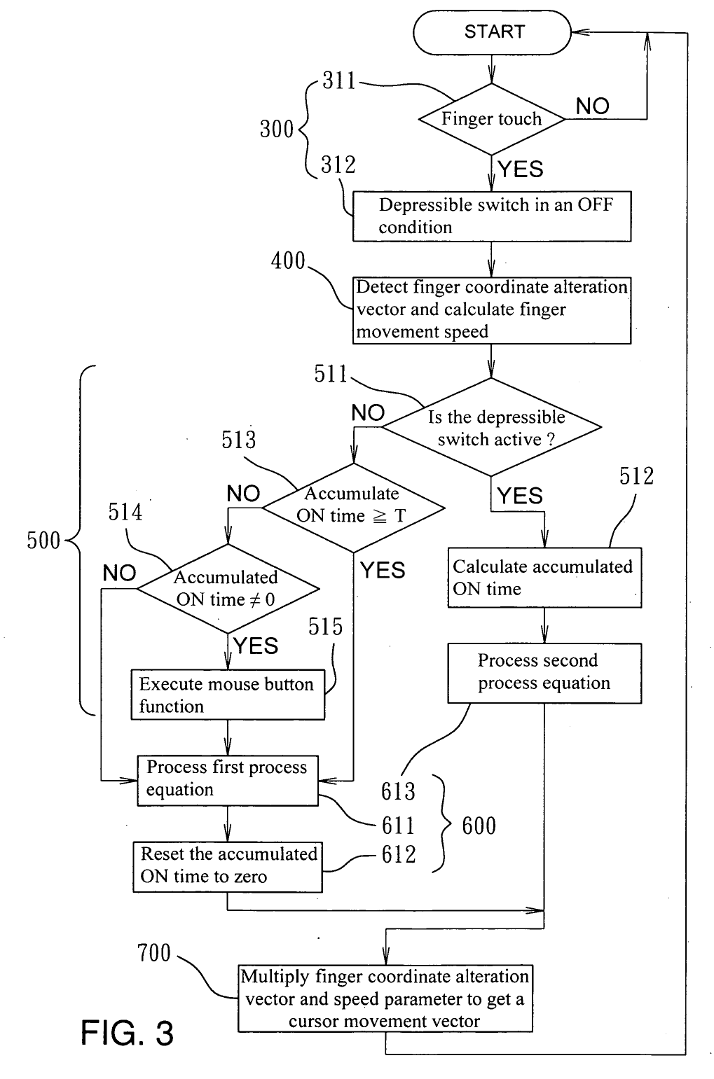

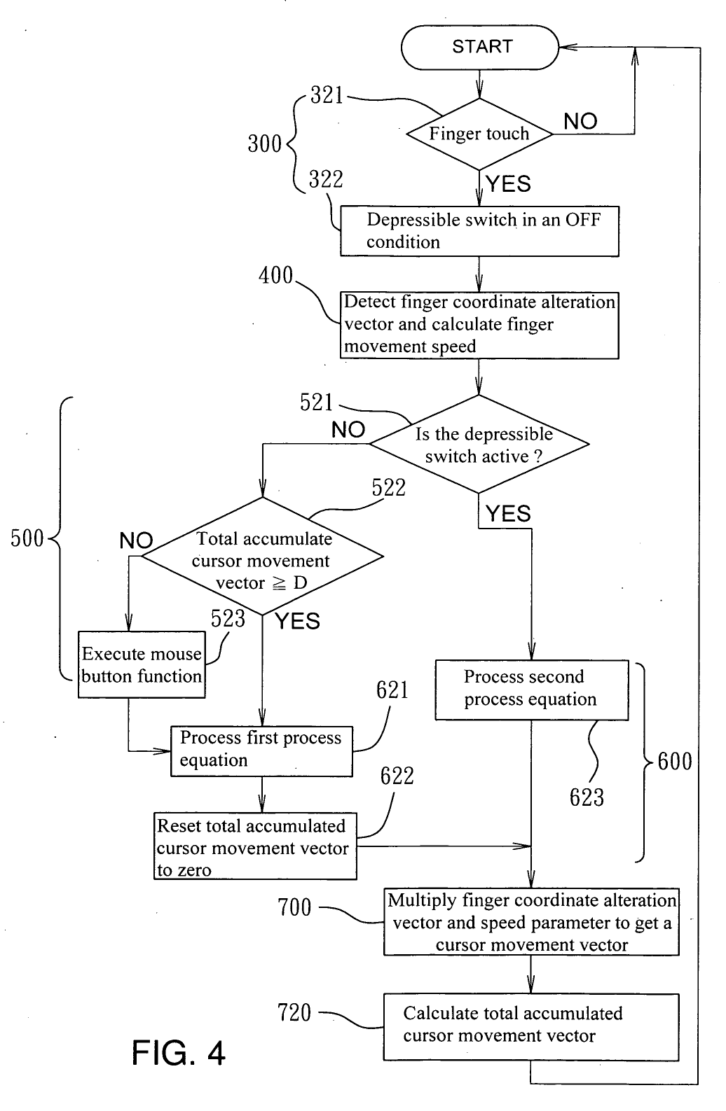

The method of the invention can be implement by adopting accumulated ON time (referring to FIG. 3), or total accumulated cursor movement vector (referring to FIG. 4), or the accumulated ON time and total accumulated cursor movement vector. FIG. 3 illustrates the flowchart of a first embodiment of the invention that controls cursor movement speed and action of mouse button function through the accumulated ON time. The procedures include the following steps:
a. Detect a finger on a trackpad and set a depressible switch in an OFF condition (step 300): when the finger 11 touches the trackpad 1 (step 311), the depressible switch 13 beneath is in the OFF condition (step 312);
b. Detect the finger coordinate alteration vector and calculate the finger movement speed (step 400);
c. Execute the mouse button function if accumulated ON time is smaller than the time set value while the depressible switch is in the ON condition (step 500):
   1. push the depressible switch 13 in the ON condition and start calculating accumulated ON time C (steps 511, 512);
   2. in the event that the depressible switch 13 is not being pushed, and the accumulated ON time C is less than a time set value T (C<T, steps 511, 513), and the accumulated ON time C is not zero (C≠0, step 514), execute the mouse button function (step 515, the mouse button function is the mouse left button function);
d. Prepare at least two speed parameter process equations, and calculate the speed parameter through the first process equation when the depressible switch is in the OFF condition; and calculate the speed parameter through the second process equation when the depressible switch is in the ON condition (step 600):
   1. push the depressible switch 13 in the ON condition and start calculating the accumulated ON time C (steps 511, 512), and calculate the speed parameter a through the second process equation g (V) (step 613); and
   2. in the event that the depressible switch 13 is not being pushed, and the depressible switch 13 is in the OFF condition, and the accumulated ON time C is greater than or equal to the time set value T (C≧T, step 513), or the accumulated ON time is zero (C<T, and C=0, steps 513, 514), calculate the speed parameter a through the first process equation f (v) and reset the accumulated ON time C to zero (C=0, steps 611, 612); and
e. Multiply the finger coordinate alteration vector (i.e. finger movement vector) and the speed parameter to get the cursor movement vector (step 700), namely the cursor movement vector=finger movement vector*speed parameter a.

Refer to FIG. 4 for the flowchart of a second embodiment of the invention that controls cursor movement speed and action of mouse button function through the total accumulated cursor movement vector. The procedures include the following steps:
a. Detect the finger on the trackpad and set the depressible switch in the OFF condition (step 300); when the finger 11 touches the trackpad 1 (step 321), the depressible switch 13 beneath is in the OFF condition (step 322);
b. Detect the finger coordinate alteration vector and calculate the finger movement speed (step 400);
c. Execute the mouse button function if the total accumulated cursor movement vector is smaller than a displacement set value (step 500): when the depressible switch 13 is not being pushed and the total accumulated cursor movement vector B is smaller than a displacement set value D (B<D, steps 521, 522), execute the mouse button function (step 523);
d. Prepare at least two speed parameter process equations, and calculate the speed parameter through the first process equation when the depressible switch is in the OFF condition; and calculate the speed parameter through the second process equation when the depressible switch is in the ON condition (step 600):
   1. push the depressible switch 13 in the ON condition and calculate the speed parameter a through the second process equation g (V) (steps 521, 623);
   2. in the event that the total accumulated cursor movement vector B is greater than or equal to the displacement set value D (B≧D, step 522), and the mouse button function has been executed (step 523), calculate the speed parameter a through the first process equation f (V) and reset the total accumulated cursor movement vector B to zero (B=0, steps 621, 622); and
e. Multiply the finger coordinate alteration vector and the speed parameter to get the cursor movement vector (step 700). This step further includes a branch step 720 for calculating the total accumulated cursor movement vector B.

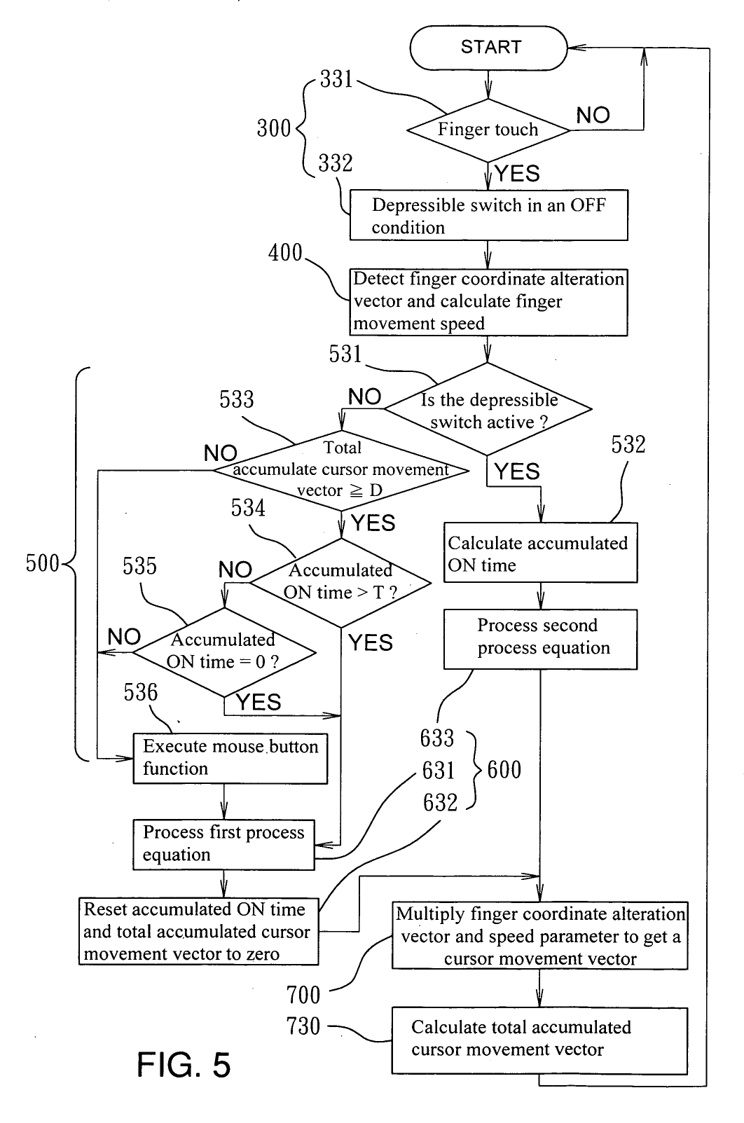

Refer to FIG. 5 for the flowchart of a third embodiment of the invention that controls cursor movement speed and action of mouse button function through the accumulated ON time and total accumulated cursor movement vector. The procedures include the following steps:
a. Detect the finger on the trackpad and set the depressible switch in the OFF condition (step 300): when the finger 11 touches the trackpad 1 (step 331), the depressible switch 13 beneath is in the OFF condition (step 332);
b. Detect the finger coordinate alteration vector and the calculate finger movement speed (step 400);
c. Execute the mouse button function if the total accumulated cursor movement vector is smaller than the displacement set value or the accumulated ON time in the ON condition is less than the time set value (step 500):
   1. push the depressible switch 13 in the ON condition and start calculating the accumulated ON time C (steps 531, 532);
   2. in the event that the depressible switch 13 is not being pushed, and the total accumulated cursor movement vector B is smaller than the displacement set value D (B<D, steps 531, 533), or the accumulated ON time C is less than the time set value T, and the accumulated ON time C is not zero (C<T and C≠0, steps 534, 535), execute the mouse button function (step 536);
d. Prepare at least two speed parameter process equations, and calculate the speed parameter through the first process equation when the depressible switch is in the OFF condition; and calculate the speed parameter through the second process equation when the depressible switch is in the ON condition (step 600):
   1. push the depressible switch 13 in the ON condition and calculate the accumulated ON time C (steps 531, 532) and the speed parameter a through the second process equation g (V) (step 633);
   2. when the depressible switch 13 is not being pushed and in the OFF condition, and the total accumulated cursor movement vector B is greater than or equal to the displacement set value D (B≧D), and the accumulated ON time C is greater than or equals to the time set value T (C≧T), (steps 531, 533, 534), or the accumulated ON time C is zero (C=0, step 535), and the mouse button function has been executed (step 536), calculate the speed parameter a through the first process equation f (V) (step 631), and reset the accumulated ON time C and total accumulated cursor movement vector B to zero (c=0, B=0, step 632); and
e. Multiply the finger coordinate alteration vector and the speed parameter to get the cursor movement vector (step 700). This step further includes a branch step 720 for calculating the total accumulated cursor movement vector B.

In the third embodiment set forth above, at the step 500 of the procedure c, in the ON condition of the depressible switch 13 and the accumulated ON time C is less than the time set value T, and the total accumulated cursor movement vector B is greater than or equal to the displacement set value D (C<T, B≧D, and the accumulated ON time C is zero (C=0)), execute cursor movement but without executing the mouse button function (steps 533,534, 535).

As a conclusion, the invention provides a method to control a cursor to move at multiple and variable speeds through a trackpad. Through touching conditions of a finger on the trackpad and changes of depressing time and user's finger movement displacement cursor movement speed and mouse button function can be controlled. Thus control of the cursor is easier.

I claim:

1. A method of controlling cursor with multiple and variable speeds through a trackpad which has a touch pad movable up and down and a depressible switch located thereunder and is depressible by a user's finger to drive the depressible switch in an ON condition, the method comprising at least the steps of:
a. detecting the finger on the trackpad and setting the depressible switch in an OFF condition;
b. detecting a coordinate alteration vector of the finger and calculating a movement speed of the finger;
c. executing a mouse button function when total accumulated cursor movement vector is smaller than a displacement set value or accumulated ON time of the ON condition is smaller than a time set value while the depressible switch is in the ON condition;
d. preparing at least two speed parameter process equations to calculate a speed parameter; wherein the speed parameter is calculated through a first process equation while the depressible switch is in the OFF condition and the speed parameter is calculated through a second process equation while the depressible switch is in the ON condition; and
e. multiplying the finger coordinate alteration vector and the speed parameter to get a screen cursor movement vector.

2. The method of claim 1, wherein a cursor movement is executed and the executing a mouse button function at step c is suspended when the accumulated ON time of the depressible switch in the ON condition is smaller than the time set value and the total accumulated cursor movement vector is greater than or equal to the displacement set value.

3. The method of claim 1, wherein the executing a mouse button function at step c is performed when the total accumulated cursor movement vector is smaller then the displacement set value while the depressible switch is in the ON condition.

4. The method of claim 1, wherein the executing a mouse button function at step c is performed when the accumulated ON time is less than the time set value while the depressible switch is in the ON condition.

5. The method of claim 1, wherein the mouse button function is a mouse left button function.

6. The method of claim 1, wherein the speed parameter derived from the second process equation is greater than that derived from the first process equation.
